(19) United States
(12) Patent Application Publication
(10) Pub. No.: US 2007/0185748 A1
(43) Pub. Date: Aug. 9, 2007

(54) Method for tracking hand-harvested field crops

(76) Inventors: Noel Wayne Anderson, Fargo, ND (US); Douglas Jeffrey Dickman, Normal, IL (US); Stephen Michael Faivre, Kingston, IL (US); Timothy Amos Wilcox, Loraine, IL (US)

Correspondence Address: DEERE & COMPANY, ONE JOHN DEERE PLACE, MOLINE, IL, 61265, US

(21) Appl. No.: 11/348,910

(22) Filed: Feb. 7, 2006

(51) Int. Cl. G06F 9/44; G07F 19/00; G06F 7/00; G08B 13/14; G08B 23/00

(52) U.S. Cl. 705/7; 705/30; 235/376; 340/573.1; 340/572.1

(57) ABSTRACT

A method for tracking hand-harvested field crops includes outfitting each worker that is working in the field with a corresponding first wireless communication device; associating with each produce crate that is actively used in the field a corresponding second wireless communication device; generating localization data to define each field region contributing to a filling of a particular produce crate with produce; and generating tracking information for tracking a crop flow from a particular worker to the particular produce crate using information provided by the corresponding first wireless communication device, the corresponding second wireless communication device, and the localization data.

### FIELD OF THE INVENTION

The present invention is directed to tracking crops, and more particularly, to a method for tracking hand-harvested field crops.

### BACKGROUND OF THE INVENTION

The ability to trace mechanically harvested crops, such as corn, wheat, and beans, has improved over the years by using yield monitors with global positioning system (GPS) receivers. Also, bar codes and radio frequency identification (RFID) readers facilitate the tracking of fruits and vegetables after arriving in crates at processing plants like other industries handle components and finished goods through a factory.

One closed environment where crop tracing has been used to track hand-harvested crops is the hydroponic environment. A key feature of this environment is that electrical power for data acquisition and transfer is readily available. Also, the hydroponic environment is an indoor environment that permits the use of equipment designed for use in warehouses versus the harsher outdoors. In addition, hydroponic crops, e.g., tomatoes, command a price premium that can cover higher information technology costs, in contrast to fruits and vegetables grown outdoors.

Also, there are key differences between produce grown on trees or shrubs, and produce grown in open fields. One difference is that trees or shrubs persist from year to year with tractor-wide rows between them, whereas stem or vine produce, e.g., vegetables, grown in open fields have narrower rows with different harvest item field aggregation. Another difference is that the tree canopies can block or degrade electronic signals, whereas stem or vine produce grown in outdoor fields typically have open skies. Still another difference is that the fields of stem or vine produce typically are plowed up at the end of the growing season.

Several companies, such as Timex and Garmin, have developed and sell wearable GPS receivers, and such GPS receivers may be tied into other sensors. Such GPS receivers may be, for example, geared to athletes who are interested in heart rate and motion records, or other outdoor activities. Such devices currently sell for about $100 to $350, depending on features, and have a battery life of up to about 13 hours.

### SUMMARY OF THE INVENTION

The present invention facilitates the tracking of hand-harvested crops from the field from which the produce was picked to the produce crate that receives the picked produce, and then transported to a storage or processing facility.

The invention, in one form thereof, is directed to a method for tracking hand-harvested field crops. The method includes outfitting each worker that is working in a field with a corresponding first wireless communication device; each corresponding first wireless communication device uniquely identifying a particular worker of a plurality of workers working in the field; associating with each produce crate that is actively used in the field a corresponding second wireless communication device, each corresponding second wireless communication device identifying at least one produce crate of a plurality of produce crates being used in the field; generating localization data to define each field region contributing to a filling of a particular produce crate with produce; and generating tracking information for tracking a crop flow from the particular worker to the particular produce crate using information provided by the corresponding first wireless communication device, the corresponding second wireless communication device, and the localization data.

The invention, in another form thereof, is directed to a method for tracking hand-harvested field crops. The method includes outfitting each worker that is working in the field with a corresponding first wireless communication device; associating with each produce crate that is actively used in the field a corresponding second wireless communication device; generating localization data to define each field region contributing to a filling of a particular produce crate with produce; generating tracking information for tracking a crop flow from a particular worker to the particular produce crate using information provided by the corresponding first wireless communication device, the corresponding second wireless communication device, and the localization data; and forwarding the tracking information to a central processing station.

### BRIEF DESCRIPTION OF THE DRAWINGS

FIG. 1 is an exemplary diagrammatic representation of a field having a plurality of dynamic field regions from which produce is picked and tracked in accordance with embodiments of the present invention.

FIG. 2 is a flowchart of a general method for tracking hand-harvested field crops.

FIG. 3 is an embodiment of a monitoring device that may be used in association with the method of FIG. 2.

FIG. 4 is an exemplary diagrammatic representation of a field in which a network is established having a plurality of nodes positioned at various locations in the field.

FIG. 5 is an exemplary diagrammatic representation of a field in which there is operating a passive harvest vehicle configured to carry produce crates to a central location on the vehicle.

### DESCRIPTION OF THE PREFERRED EMBODIMENT

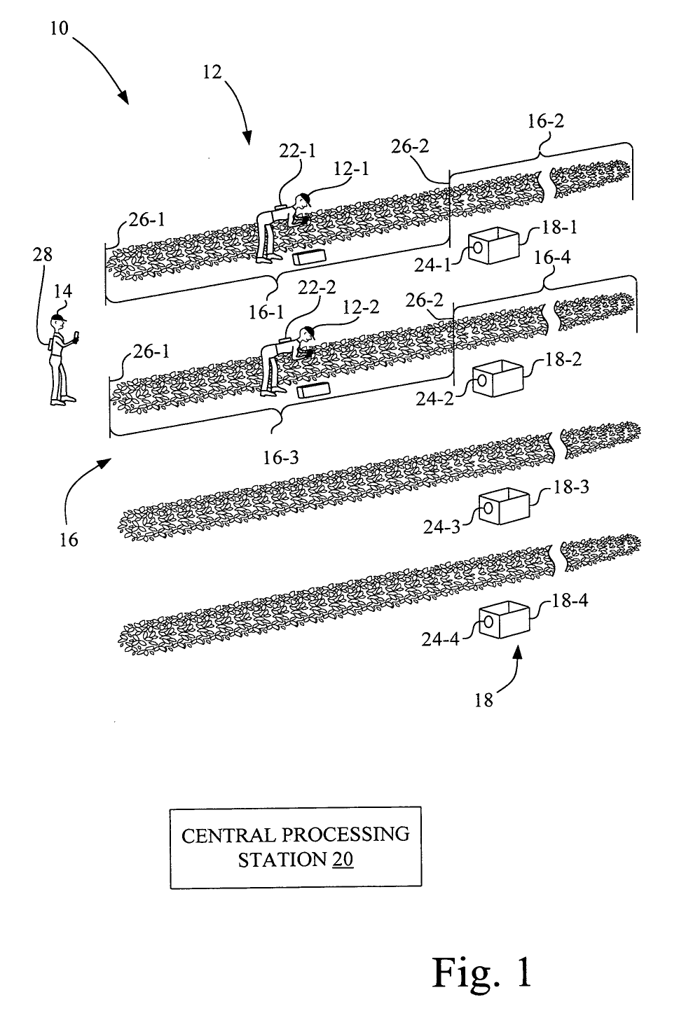

Referring now to the drawings, there is shown in FIG. 1 an exemplary diagrammatic representation of a field 10. Field 10 yields a low-profile produce crop, such as vegetables, tomatoes, strawberries, etc., which is to be hand-harvested. Working in field 10 is a plurality of workers 12, individually identified in the example of FIG. 1 as worker 12-1 and worker 12-2, who perform hand-harvesting of the produce crop of field 10. Also working in field 10 is a supervisor 14.

In the example of FIG. 1, it is shown that within field 10 there is a plurality of dynamic field regions 16, individually identified in the example of FIG. 1 as field region 16-1, field region 16-2, field region 16-3, and field region 16-4. The field regions 16 shown in FIG. 1 are dynamic and exemplary, since the location of a particular field region will depend on the starting and stopping locations of a particular harvesting operation performed by one or more of workers 12. In other words, field regions 16 are not predefined locations in field 10, but rather, will be defined during the course of the harvesting operation by the work locations associated with workers 12. For convenience, the term “field regions” includes both one-dimensional field aspects, i.e., a particular row of crops in the field, or two-dimensional field aspects, e.g., a particular area of the field that may include multiple rows of crops.

Placed in field 10 is a plurality of produce crates 18, e.g., boxes, individually identified in the example of FIG. 1 as produce crate 18-1, produce crate 18-2, produce crate 18-3, and produce crate 18-4. A remote central processing station 20 is provided to receive tracking information relating to crop flow within, and out of, field 10.

The hand-picked produce is optionally placed in a tray, or other small container, e.g., bucket, before being placed in one of the produce crates 18 for transport to a storage and processing facility. Typically, such produce crates 18 are made of cardboard, wood, or plastic, and may be, for example, approximately 1.5 feet×2 feet×1.5 feet in size. A number of the plurality of produce crates 18 may be in close proximity with each other. Accordingly, each produce crate may receive produce of mixed grades, which are then sorted at a remote location. Alternately, each produce crate may be designated to receive produce of a particular grade. For example, vegetables in a particular produce crate, e.g., produce crate 18-1, may be picked from a particular field region by a particular worker, or over multiple field regions, e.g., multiple rows, of the plurality of field regions 16 and harvested by multiple workers 12.

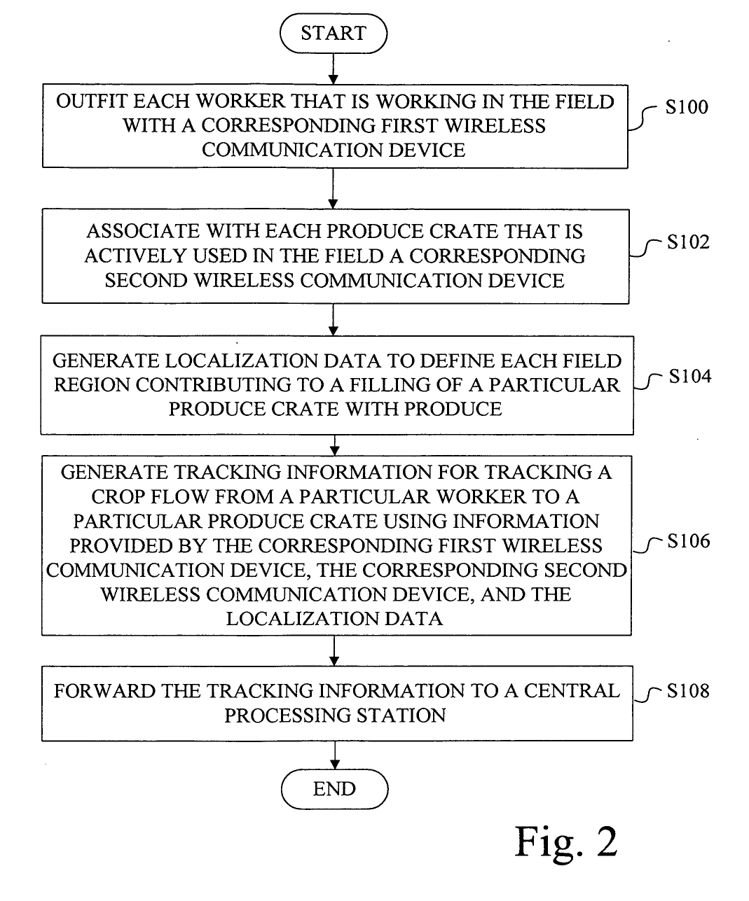

FIG. 2 is a flowchart of a general method for tracking hand-harvested field crops, in accordance with embodiments of the present invention. Following the discussion of the general steps set forth in FIG. 2, several exemplary embodiments illustrating application of the method will be described.

At step S100, each worker 12-1, 12-2 of the plurality of workers 12 that is working in field 10 is outfitted with a corresponding wireless communication device 22, the corresponding wireless communication device being individually identified as wireless communication device 22-1 and wireless communication device 22-2 in the example of FIG. 1. Each corresponding wireless communication device 22-1, 22-2 uniquely identifies a particular worker 12-1, 12-2, respectively, of the plurality of workers 12 working in field 10.

Each of the wireless communication devices 22 may be designed to be worn by the respective worker. For example, each of the wireless communication devices 22 may be configured as a belt, necklace or backpack, or configured for attachment to an article of clothing worn by a worker, or to the worker's tray. Wireless communication devices 22 are designed such that their size and weight will not impair the harvest work or tire the workers from the added weight.

At step S102, associated with each produce crate 18-1, 18-2, 18-3, 18-4 of the plurality of produce crates 18 that is actively used in field 10 is a corresponding wireless communication device 24, each corresponding wireless communication device being individually identified as wireless communication device 24-1, wireless communication device 24-2, wireless communication device 24-3, and wireless communication device 244. Each corresponding wireless communication device 24-1, 24-2, 24-3, 24-4 identifies at least one of produce crates 18-1, 18-2, 18-3, 18-4, respectively, of the plurality of produce crates 18 being used in field 10. Each wireless communication device 24, for example, may be physically located on, e.g., detachably attached to, a respective produce crate of the plurality of produce crates 18.

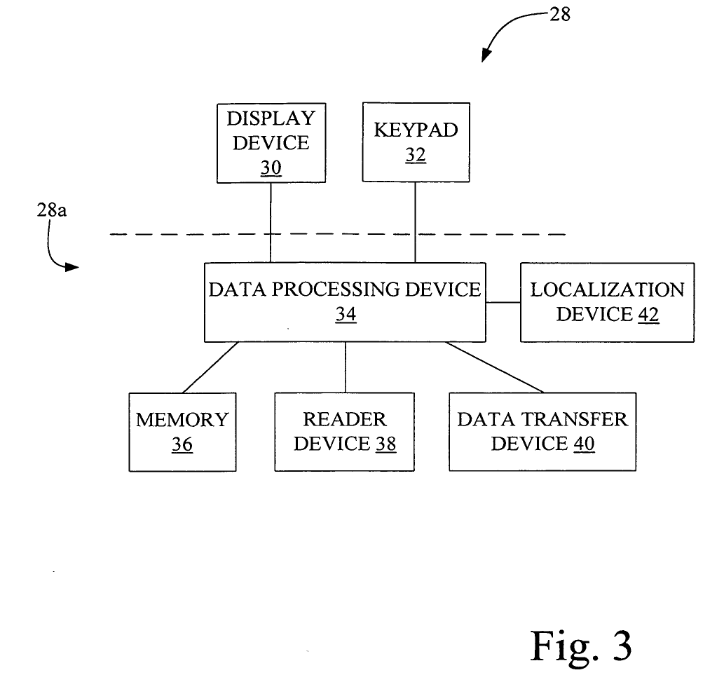

At step S104, localization data is generated, e.g., on a per worker basis, to define each field region of the plurality of field regions 16 contributing to the filling of a particular crate with produce. For example, each field region, e.g., field region 16-1, will be defined by a start harvest location 26-1 and an end harvest location 26-2, which may be associated with a particular worker, e.g., worker 12-1 contributing to the filling of the particular crate 18-1. In some circumstances, multiple workers 12-1, 12-2, and/or multiple field regions, e.g., field regions 16-1, 16-3, may contribute to the filling of a particular crate, e.g., produce crate 18-1. The localization data may be generated with the aid of a localization device, such as for example a monitor device 28 or 28a having a localization device 42 (see FIG. 3), such as a GPS receiver, or other device capable of providing location data, e.g., longitude/latitude, etc.

At step S106, tracking information for tracking a crop flow from a particular worker, e.g., worker 12-1, to a particular produce crate, e.g., produce crate 18-1, is generated, e.g., by monitor device 28 or 28a, using information provided by, in this example, the corresponding wireless communication device 22-1, the corresponding wireless communication device 24-1, and the localization data provided, for example, by localization device 42. Thus, the tracking information is in the form of an electronic record of the worker or workers associated with the produce contained in a particular produce crate.

At step S108, the tracking information, generated through automated data collection, is forwarded, e.g., by monitor device 28 or 28a, or a removable memory device, to central processing station 20. Central processing station 20 may, for example, execute program instructions to process the tracking information to perform various tasks, such as generating payroll and/or supply chain management operations, based on the tracking information. For example, the tracking information may be used to provide merit pay adjustments based on the quality of produce, e.g., vegetables, harvested as well as quantity. In addition, the tracking information may be used to identify workers who may have good work ethics, but need training to improve their harvesting skills.

Further, the tracking information may be used for field region and/or whole field management. For example, the tracking information facilitates tracing quality and quantity of produce harvested from a particular field region, e.g., field region 16-1, field region 16-2, etc., in field 10, which in turn may be used, for example, by a management computer, to make management decisions about fertilizing, irrigation, tillage practices, etc., for that field region or the entire field.

### Embodiment 1

In summary, in Embodiment 1, tracking crop flow (see step S106 of FIG. 2) is performed using a monitor device 28. In this embodiment, as shown in FIG. 1, monitor device 28 is configured, for example, as a data terminal wearable by supervisor 14. Referring to FIG. 3, monitor device 28 may include, for example, a display device 30, a keypad 32, a data processing device 34, a memory 36, a reader device 38, a data transfer device 40, and a localization device 42.

Display device 30 may include an LCD display and/or indicator lights for displaying user menus and tracking information. Keypad 32 facilitates manual entry of information, where necessary or desired. Data processing device 34 includes a microprocessor, and executes program instructions retrieved from memory 36. Memory 36 may be one or more of random access memory (RAM), read-only memory (ROM) and non-volatile RAM. Reader device 38 may be, for example, a radio frequency identification (RFID) tag reader or a bar code reader.

Data transfer device 40 transfers the tracking information generated at step S106 to central processing station 20. Data transfer device 40 may be a physical media, such as a compact flash or similar removable memory device, or it may be a long range wireless link such as cell phone, Wi-Fi, Wi-Max, etc., or a short range wireless link, such as Zigbee, Bluetooth, or IEEE 802.11.

Localization device 42 is used to generate localization data relating to a location in field 10 where produce, e.g., vegetables, in a particular produce crate of the plurality of produce crates 18 was harvested. Localization device 42 may be, for example, a GPS receiver, or other device capable of providing location data, e.g., longitude/latitude, etc.

At the start of a work shift, for example, supervisor 14 operates monitor device 28 to record all start harvest locations 26-1 associated with field regions 16, all workers 12, and all produce crates 18 grouped together as an ensemble for a hand-harvest activity. Once a particular produce crate, e.g., produce crate 18-1, is filled with produce, supervisor 14 operates monitor device 28 to record the associated end harvest location 26-2, thereby defining the field region(s) 16 associated with the particular produce crate.

Monitor device 28 is configured to generate localization data relating to the time and location of each start harvest location 26-1 and each end harvest location 26-2 for each field region, and automatically read identification (ID) information provided by each wireless communication device 22 and each wireless communication device 24 to correlate the produce, e.g., vegetables, picked in a particular field region, e.g., field region 16-1 by a particular worker, e.g., worker 12-1, with a particular produce crate, e.g., produce crate 18-1. In other words, monitor device 28 monitors the work flow of each worker with respect to particular field regions and particular produce crates, and infers that the produce in the particular produce crate was picked between a particular start harvest location 26-1 and a particular end harvest location 26-2.

Whenever a field region is finished, a new field region is started, a worker arrives, a worker leaves, a crate is filled, or an empty crate is put into service, supervisor 14 generates the pertinent localization data and reads the ID information and confirms entry or exit from service. Taken together, the active field regions, workers, and produce crates define the crop flow for traceability purposes. A number of harvest ensembles may be active in field 10 at a given time and a single supervisor 14 may have responsibility for multiple ensembles, which is accommodated by monitor device 28.

Since all worker and produce crate information is read by monitor device 28, each wireless communication device 22 associated with workers 12 may be a passive identification device. Likewise, each wireless communication device 24 associated with produce crates 18 may be a passive identification device. The passive identification device may be, for example, a radio frequency identification (RFID) tag. Alternatively, the passive identification device may be a bar code. The display and/or an optional audio output on monitor device 28 gives an indication of a successful read of the wireless communication devices 22 and 24 by the reader device 38 of monitor device 28.

Due to the potential remote location of field 10, each of wireless communication devices 22 and 24, and monitor device 28, may be powered by a portable energy source, if required, such as powered by batteries or a fuel cell. The power source needs to provide ample power for the desired period of time without power interruption, e.g., a work shift, a day, a season, or longer. Also, use of low power technologies will extend the time before battery replacement is required.

### Embodiment 2

In Embodiment 2, each worker's corresponding wireless communication device 22 includes a monitor device 28a (see FIG. 3), which may be similar to the construction of monitor device 28, but with reduced features to cut down on cost. Each wireless communication device 22 may be configured as a wearable device. Monitor device 28a includes data processing device 34, memory 36, reader device 38, data transfer device 40, and localization device 42. Alternatively, however, one or more of the corresponding wireless communication device 22 may include the full-featured monitor device 28 to display such items as daily harvest total, and the area of the field already harvested, or to be harvested, etc.

In Embodiment 2, the tracking step S106 of FIG. 2 is performed using monitor device 28a of a worker's wireless communication device 22, e.g., wireless communication device 22-1 of worker 12-1, to generate localization data and to read information provided by each produce crate's wireless communication device 24, e.g., wireless communication device 24-1 of produce crate 18-1, communicatively engaged by wireless communication device 22-1, which in this example, correlates the produce, e.g., vegetables, picked from a particular field region, by the particular worker 12-1, with the particular produce crate 18-1.

Workers may still have RFID tags which may be read by either of monitor device 28 or monitor device 28a. Alternatively, where monitor device 28 is used, a worker may enter a worker ID manually via keypad 32 at the beginning and end of each work period. In embodiments where each crate's wireless communication device 24 is an RFID tag, it may be desirable for the crate RFID tags to be readable from a distance of less than a meter.

In order to lengthen the work time available from the plurality of wireless communication devices 22 used by workers 12, each worker's wireless communication device 22 operates in an active mode only periodically to conserve electrical power. Further, each worker's wireless communication device 22 is configured, e.g., through the execution of program instructions, to perform a learning operation by analyzing the tracking information to determine an optimal periodic sampling time for operating in the active mode.

For example, the optimal sampling period for a worksite will depend on a variety of factors, such as for example, the difficulty of harvesting the produce, the size of the produce and trays, and the distance from the field region to the produce crate. This optimal sampling period may range, for example, from several times a minute to once every several minutes. To further reduce energy use, the period may be variable as a part of an adaptive learning component, recognizing that once a harvest of a particular field region has started, it will be a while before the tray is full and needs to be emptied into a produce crate. Thus, the sampling period may be lengthened. As the estimated level of the tray increases, the sampling rate may be increased so that the transfer of the produce from the tray to the produce crate is captured. The sampling period then may be decreased once a field region identification, e.g., localization data generated by wireless communication device 22, is again read.

At the end of the work shift, each of the wireless communication devices 22 are retrieved from each of the workers 12 and the tracking information may be transferred via a short range wireless or physical storage media to central processor station 20. Alternatively, long range wireless, e.g., Wi-Max and cellular phone, may be used to transfer tracking information throughout the work shift.

In Embodiment 2, the work path taken, for example, by worker 12-2 may cause wireless communication device 22-2 of worker 12-2 to read multiple produce crates, e.g., produce crate 18-1 and produce crate 18-2.

In one scenario of the above, assume that worker 12-2 walks past produce crate 18-2 to empty a tray of produce, e.g., vegetables, in produce crate 18-1. If wireless communication device 22-2 of worker 12-2 reads multiple crate wireless communication devices, e.g., wireless communication device 24-2 and then wireless communication device 24-1, corresponding to produce crates 18-2 and 18-1, respectively, then it is inferred that the last wireless communication device 24-1 of the multiple wireless communication devices 24-1 and 24-2 that is engaged by wireless communication device 22-2 of worker 12-2 identifies the particular produce crate 18-1 in which worker 12-2 emptied the tray of produce, e.g., vegetables. When the corresponding wireless communication device 24 of a particular produce crate 18 is no longer read by a worker's corresponding wireless communication device 22, then it is inferred that the produce crate has been left behind or forwarded to a collection point.

In another scenario, assume worker 12-1 walks past produce crate 18-1 to empty a tray of produce, e.g., vegetables, in produce crate 18-2. If the wireless communication device 22-1 of worker 12-1 reads both wireless communication device 24-1 of produce crate 18-1 and wireless communication device 24-2 of produce crate 18-2, then it is inferred that the particular wireless communication device of the multiple wireless communication devices 24-1 and 24-2 that is engaged by wireless communication device 22-1 for the longest period of time identifies the particular produce crate in which worker 12-1 emptied the tray of produce.

Alternatively, it may be inferred that a particular wireless communication device of the multiple wireless communication devices 24-1 and 24-2 having the strongest signal strength signature read by wireless communication device 22-1 identifies the particular produce crate in which worker 12-1 emptied the tray of produce.

In another scenario, each of wireless communication device 24-1 corresponding to produce crate 18-1, wireless communication device 24-2 corresponding to produce crate 18-2, wireless communication device 24-3 corresponding to produce crate 18-3, and wireless communication device 24-4 corresponding to produce crate 18-4 includes a plurality of RFID tags positioned at different locations, e.g., on multiple sides, on the respective produce crate 18-1, 18-2, 18-3, and 18-4. In this scenario, assume worker 12-1 walks past produce crate 18-1 to empty a tray of produce, e.g., vegetables, in produce crate 18-2. If wireless communication device 24-1 of worker 12-1 reads multiple wireless communication devices 24-1, 24-2 corresponding to produce crates 18-1, 18-2, respectively, then it is inferred that a particular wireless communication device 24-2 of the multiple wireless communication devices 24-1, 24-2 having the most RFID tags read by wireless communication device 22-1 identifies the particular produce crate in which worker 12-1 emptied the tray of produce, e.g., vegetables.

### Embodiment 3

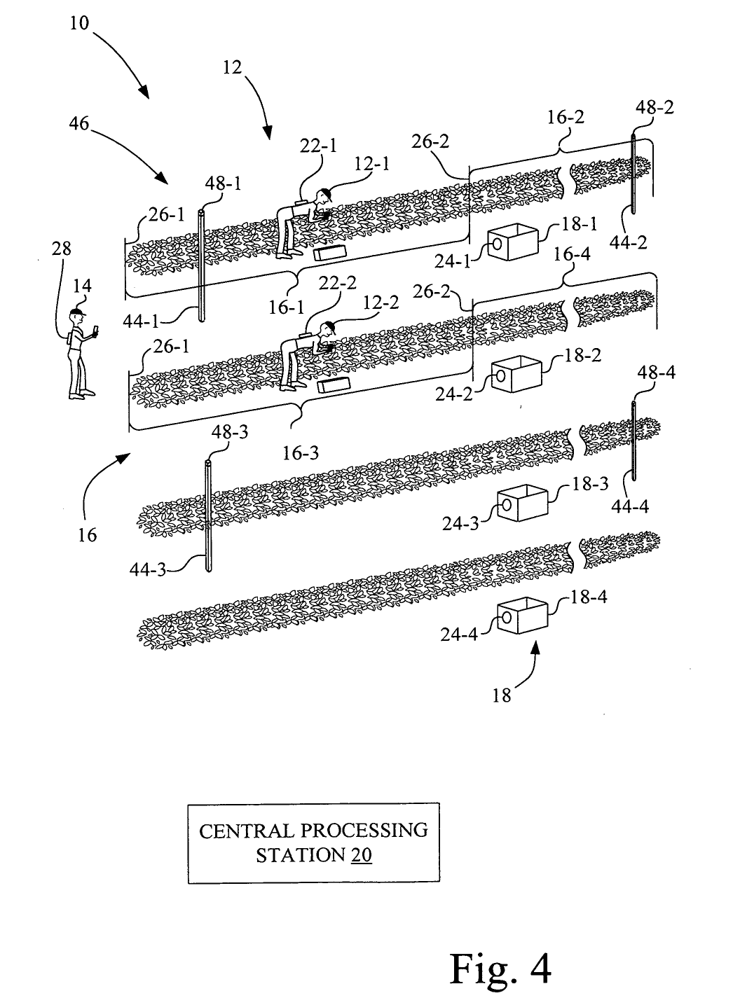

In Embodiment 3, referring to FIG. 4, a plurality of posts 44, individually identified in this example as post 44-1, post 44-2, post 44-3, post 44-4, is positioned at various locations in field 10. A low power network 46 is established in field 10, with a wireless network node 48 being established at each post of the plurality of posts 44. In the example of FIG. 4, a wireless network node 48-1 is located at post 44-1, a wireless network node 48-2 is located at post 44-2, a wireless network node 48-3 is located at post 44-3, and a wireless network node 48-4 is located at post 44-4. Each wireless network node 48-1, 48-2, 48-3 and/or 48-4, reads each worker's corresponding wireless communication device 22 that is communicatively engaged by the corresponding wireless network node 48, and each worker's corresponding wireless communication device 22 reads each crate's corresponding wireless communication device 24 that is communicatively engaged by the corresponding worker's wireless communication device 22, to correlate the produce picked from a particular field region by a particular worker with a particular produce crate.

In addition, each wireless network node 48 may provide localization data based on their permanent location in field 10, and provide localized field sensing, such as temperature sensing, moisture sensing, etc. Such temperature sensors may be used for helping determine when to cover the crops. Soil moisture sensors may be used to help manage irrigation. Also, the nodes, with unique IDs, may be used to localize autonomous tractors moving along the rows of crops in field 10.

In one scenario, each worker's wireless communication device 22 and each crate's wireless communication device 24 may be another node on the wireless network 46, or a passive identification device, such as an RFID tag.

In another scenario, each worker's wireless communication device 22 is a monitor device, such as monitor device 28 or monitor device 28a, and each crate's wireless communication device 24 may be another node on the wireless network, or a passive identification device, such as an RFID tag. The tracking of step S106 is performed using monitor device 28, or monitor device 28a, to read information provided by each crate's wireless communication device 24 communicatively engaged by the monitor device. The monitor device then is used to transmit the tracking information to a closest wireless network node 48 on the wireless network 46. For example, referring to FIG. 4, the monitor device represented by wireless communication device 22-1 associated with worker 12-1 would transmit the tracking information to the node represented by wireless network node 48-1 on the wireless network 46 associated with field 10.

The low power network 46 may access the outside world through, but not limited to, one or more of the following: (a) a stationary FNIS node, (b) network gateways on vehicles such as tractors, or (c) data collection devices, e.g., wireless communication devices 22, 24, wireless network nodes 48, and monitor devices 28 and 28a, as described in the previous embodiments.

In one variant of this embodiment, the base network is permanent and multifunction in that it is used for field sensing and localization as well as to track crop flow. Power is conserved by limiting transmit power to be adequate for reaching the adjacent 4-8 posts rather than, say, the typical full 50 meter range of Zigbee. Power is also conserved by implementing a variable duty cycle, i.e., when there is not much activity in the field, such that nodes may wake up only once a day during periods of relative inactivity, but at critical times such as harvest, drought, or frost, nodes may wake up several times an hour or a minute.

Workers 12 and produce crates 18 have corresponding wireless communication devices 22 and 24, respectively, providing ID information based on short range wireless and/or RFID. For example, when a worker empties a tray of produce into a produce crate, a node worn by the worker picks up the ID of the produce crate. Whether the produce crate ID is an RFID tag or another short range wireless node, issues in automatically disambiguating adjacent produce crates as the recipient of produce exist as described and solved in Embodiment 2 described above. The end result is that the device worn by the worker contains the ID of the produce crate receiving the produce.

When the worker returns within range of a particular wireless network node 48, the previous field region-vegetables-worker-crate association is transferred to the particular wireless network node 48. If a worker is close to a particular wireless network node 48, e.g., node 48-1, based on relative signal strength of all node signals being received, for a period of time, that node ID is logged in the worker node as the current field region. The current field region is used in constructing the next field region-vegetables-worker-crate association. These associations may have a time stamp added to assist in reconstructing the produce movement from field region to crate. In this embodiment, the only long term data storage is in the wireless network nodes 48. Also, the tracking information leaves field 10 when the wireless network node 48 on the network 46 communicates with a gateway node of another network.

In another variation of this embodiment, a localization device (e.g., GPS) may be provided and an optional scale provided. The GPS tagged data may be later referenced to a map of the field. The optional scale may be used to weigh and record tray contents.

### Embodiment 4

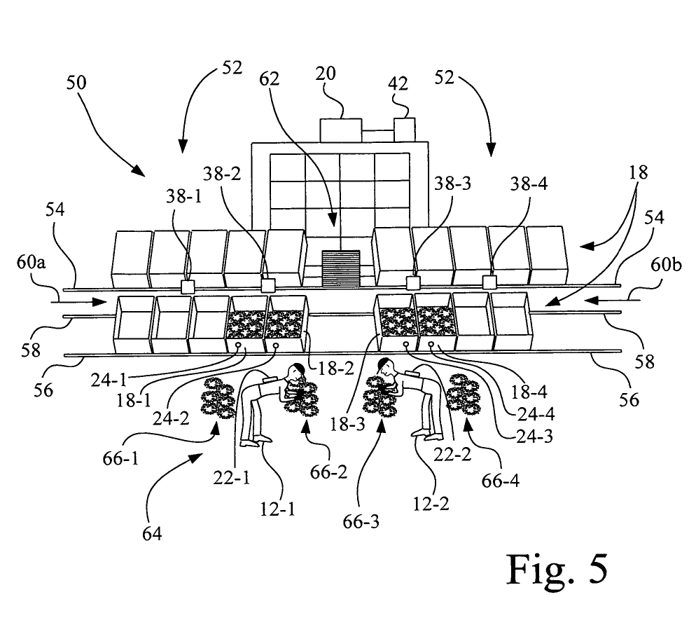

As shown in FIG. 5, in the Embodiment of FIG. 4, a passive harvesting vehicle 50, such as a truck or trailer bed, is provided that includes a pair of wings 52 having an upper crate shelf 54, a lower crate shelf 56 and a conveyor 58. Upper crate shelf 54 provides a supply of empty produce crates 18 for use by workers 12. Lower crate shelf 56 supports produce crates 18 that are being filled by workers 12. Conveyor 58 transports produce crates 18 that are filled with produce in the direction indicated by arrows 60a, 60b to a central location 62 between the wings 52. Thereafter, the filled crates are stacked on vehicle 50.

For example, as vehicle 50 moves through a field 64 having crop rows 66-1, 66-2, 66-3, 66-4, the workers 12-1, 12-2, walk behind the wings 52 and put ripe produce into produce crates 18 supported by lower crate shelf 56. Once a crate is filled with produce, the produce crate is pushed forward onto conveyor 58. Conveyor 58 then carries the filled produce crates 18 to the central location 62 on vehicle 50 for aggregation. On less mechanized vehicles, conveyor 58 may be replaced by a walkway for a human to carry filled/empty produce crates 18 along wings 52 to the central location 62 of vehicle 50.

A plurality of reader devices 38, e.g., RFID readers, individually identified as reader devices 38-1, 38-2, 38-3, 38-4, are placed at spaced intervals on wings 52, and are used to read wireless communication devices 24, e.g., RFID tags, on produce crates 18 (shorter range), and to read wireless communication devices 22, e.g., RFID tags, on workers 12 (longer range). It is assumed that workers 12 are putting the produce in the produce crates in front of them as they walk along the crop rows 66 in field 10.

Central processing station 20 may be established on vehicle 10, and is communicatively coupled to localization device 42, e.g., a GPS receiver, and to reader devices 38-1, 38-2, 38-3, 38-4. Central processing station 20 reads localization device 42 and reader devices 38-1, 38-2, 38-3, 38-4 at intervals tied to time, e.g., distance traveled, etc., and determines each field region contributing to the filling of a particular produce crate 18. Based on known positions of the reader devices 38-1, 38-2, 38-3, 38-4 relative to the localization device 42, workers 12 and product crates 18 are localized in space and time with respect to field 64.

Having described various preferred embodiments, it will become apparent that various modifications can be made without departing from the scope of the invention as defined in the accompanying claims.

1. A method for tracking hand-harvested field crops, comprising:
outfitting each worker that is working in a field with a corresponding first wireless communication device, each said corresponding first wireless communication device uniquely identifying a particular worker of a plurality of workers working in said field;
associating with each produce crate that is actively used in said field a corresponding second wireless communication device, each said corresponding second wireless communication device identifying at least one produce crate of a plurality of produce crates being used in said field;
generating localization data to define each field region contributing to a filling of a particular produce crate with produce; and
generating tracking information for tracking a crop flow from said particular worker to said particular produce crate using information provided by said corresponding first wireless communication device, said corresponding second wireless communication device, and said localization data.

2. The method of claim 1, further comprising forwarding said tracking information to a central processing station.

3. The method of claim 2, wherein said central processing station performs at least one of payroll and supply chain management operations based on said tracking information.

4. The method of claim 1, wherein said localization data is generated by a global positioning system (GPS) device.

5. The method of claim 1, wherein said localization data is generated by a plurality of network nodes positioned at various locations in said field.

6. The method of claim 1, wherein one said corresponding first wireless communication device is worn by said particular worker.

7. The method of claim 1, wherein said tracking is performed using a monitor device, said monitor device using said localization data and reading information provided by each first wireless communication device and second wireless communication device to correlate produce picked by said particular worker with said particular produce crate.

8. The method of claim 7, wherein a supervisor operates said monitor device to record all workers and produce crates grouped together as an ensemble for a hand-harvest activity.

9. The method of claim 1, wherein each first wireless communication device and second wireless communication device is a passive identification device.

10. The method of claim 9, wherein said passive identification device is an RFID tag.

11. The method of claim 1, wherein said corresponding first wireless communication device includes a monitor device, said tracking being performed using said monitor device to read information provided by each second wireless communication device communicatively engaged by said corresponding first wireless communication device, and using said monitor device to read said localization data, to correlate produce picked from a particular field region by said particular worker with said particular produce crate.

12. The method of claim 11, wherein said corresponding first wireless communication device operates in an active mode only periodically to conserve electrical power.

13. The method of claim 12, wherein said corresponding first wireless communication device performs a learning operation by analyzing said tracking information to determine an optimal periodic sampling time for operating in said active mode.

14. The method of claim 11, wherein if said corresponding first wireless communication device of said particular worker reads multiple second wireless communication devices corresponding to multiple produce crates, then it is inferred that a last second wireless communication device of said multiple second wireless communication devices that is engaged by said corresponding first wireless communication device identifies said particular produce crate in which said particular worker emptied a tray of produce.

15. The method of claim 11, wherein if said corresponding first wireless communication device of said particular worker reads multiple second wireless communication devices corresponding to multiple produce crates, then it is inferred that a particular second wireless communication device of said multiple second wireless communication devices that is engaged by said corresponding first wireless communication device for the longest period of time identifies said particular produce crate in which said particular worker emptied a tray of produce.

16. The method of claim 11, wherein said each corresponding second wireless communication device includes a plurality of RFID tags positioned at different locations on each produce crate of said plurality of produce crates, and wherein if said corresponding first wireless communication device of said particular worker reads multiple second wireless communication devices corresponding to multiple produce crates, then it is inferred that a particular second wireless communication device of said multiple second wireless communication devices having the most RFID tags read by said corresponding first wireless communication device identifies said particular produce crate in which said particular worker emptied a tray of produce.

17. The method of claim 11, wherein if said corresponding first wireless communication device of said particular worker reads multiple second wireless communication devices corresponding to multiple produce crates, then it is inferred that a particular second wireless communication device of said multiple second wireless communication devices having the strongest signal strength signature read by said corresponding first wireless communication device identifies said particular produce crate in which said particular worker emptied a tray of produce.

18. The method of claim 1, further comprising a network having a plurality of wireless network nodes positioned at various locations in said field, wherein each respective network node of said plurality of wireless nodes reads each corresponding first wireless communication device that is communicatively engaged by said respective network node, and each corresponding first wireless communication device reads each corresponding second wireless communication device that is communicatively engaged by said corresponding first wireless communication device, to correlate produce picked from a particular field region by said particular worker with said particular produce crate.

19. The method of claim 18, wherein said plurality of wireless network nodes provides said localization data.

20. The method of claim 18, wherein each first wireless device and each second wireless device is one of another node on said network and a passive identification device.

21. The method of claim 18, wherein each first wireless device is a monitor device and each second wireless device is an RFID tag, said tracking being performed using said monitor device to read information provided by each second wireless communication device communicatively engaged by said monitor device, and using said monitor device to transmit said tracking information to a closest wireless network node of said plurality of wireless network nodes on said network.

22. The method of claim 1, further comprising a vehicle having a pair of wings configured for conveying produce crates, and having a plurality of reader devices placed at spaced intervals on said pair of wings, said method further including reading any first wireless communication device in range of a corresponding reader device of said plurality of reader devices and reading any second wireless communication device in range of said corresponding reader device of said plurality of reader devices.

23. The method of claim 22, further comprising establishing a central processing station on said vehicle, said central processing station being communicatively coupled to a localization device, and to said plurality of reader devices.

24. The method of claim 22, wherein each of said plurality of reader devices is an RFID reader device, and each of said first wireless communication device and second wireless communication device is an RFID tag.

25. A method for tracking hand-harvested field crops, comprising:
outfitting each worker that is working in said field with a corresponding first wireless communication device;
associating with each produce crate that is actively used in said field a corresponding second wireless communication device;
generating localization data to define each field region contributing to a filling of a particular produce crate with produce;
generating tracking information for tracking a crop flow from a particular worker to said particular produce crate using information provided by said corresponding first wireless communication device, said corresponding second wireless communication device, and said localization data; and
forwarding said tracking information to a central processing station.

26. The method of claim 25, wherein said forwarding includes at least one of a wireless transmission and delivery of a removable memory card.
